(19) United States
(12) Patent Application Publication
(10) Pub. No.: US 2016/0126669 A1
(43) Pub. Date: May 5, 2016

(54) CLIP FOR BIOS CHIP

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-ZHAO HUANG, Wuhan (CN)

(21) Appl. No.: 14/601,609

(22) Filed: Jan. 21, 2015

(30) Foreign Application Priority Data
Nov. 4, 2014 (CN) 201410611431.1

(51) Int. Cl. H01R 13/627; H01R 12/70

(52) U.S. Cl. CPC H01R 13/6273; H01R 12/7076

(57) ABSTRACT

A clip for a basic input/output system (BIOS) chip includes a main body, two clipping elements, and two resilient members. The main body includes a number of connecting pins mounted on the main body, and a number of signal pins mounted on the main body electrically connected to the connecting pins and configured to couple with a programming device. The clipping elements are rotatably mounted to opposite ends of the main body and configured to latch the BIOS chip. The resilient members are mounted between the clipping members and the main body.

### FIELD

The subject matter herein generally relates to a clip for clipping a basic input/output system (BIOS) chip to be programmed.

### BACKGROUND

When data in a basic input/output system (BIOS) chip of a computer is lost or damaged, the computer cannot be started up and the BIOS chip needs to be detached from the computer to be reprogrammed.

### BRIEF DESCRIPTION OF THE DRAWINGS

Implementations of the present technology will now be described, by way of example only, with reference to the attached figures.

FIG. 1 is an assembled, isometric view of an exemplary embodiment of a clip for a basic input/output system (BIOS) chip.

FIG. 2 is an exploded, isometric view of FIG. 1.

FIG. 3 is similar to FIG. 2, isometric view of FIG. 2, but viewed from another angle.

FIG. 4 is a partially assembled view of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure relates to a clip for BIOS chip.

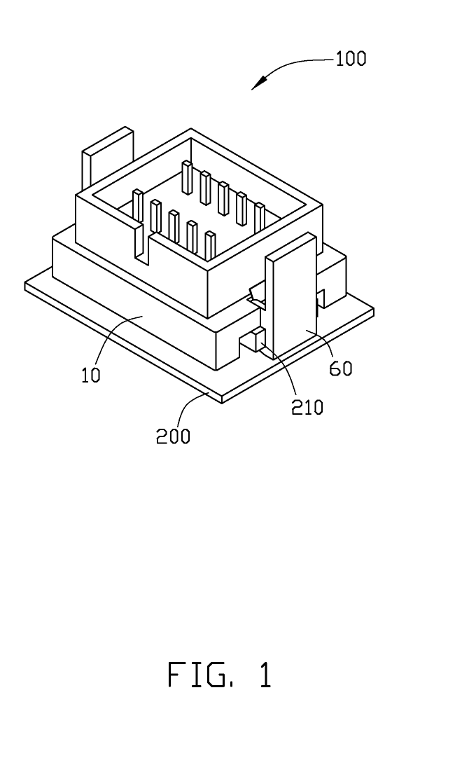

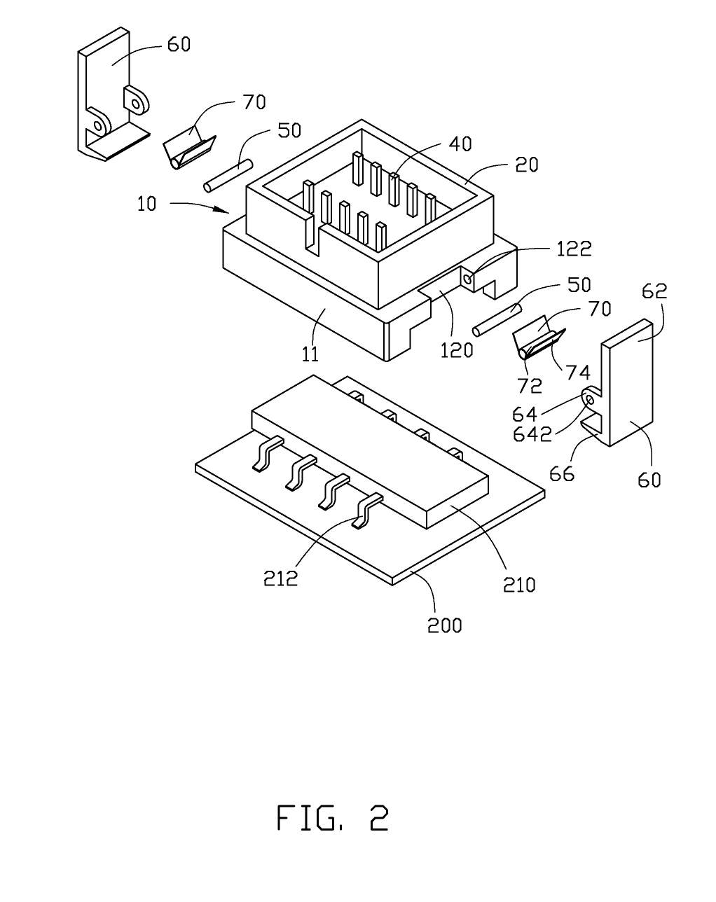

FIGS. 1 and 2 illustrate an embodiment of the clip 100 is provided to program a basic input/output system (BIOS) chip 210 with a programming device (not shown). The BIOS chip 210 is mounted to a motherboard 200. The clip 100 comprises a main body 10, two spindles 50, two clipping elements 60 and two resilient members 70. The BIOS chip 210 comprises a plurality of chip pins 212. In the embodiment, the number of the chip pins 212 is eight and the chip pins 212 are symmetrically grouped in two rows, respectively located at two opposite sides of the BIOS chip 210.

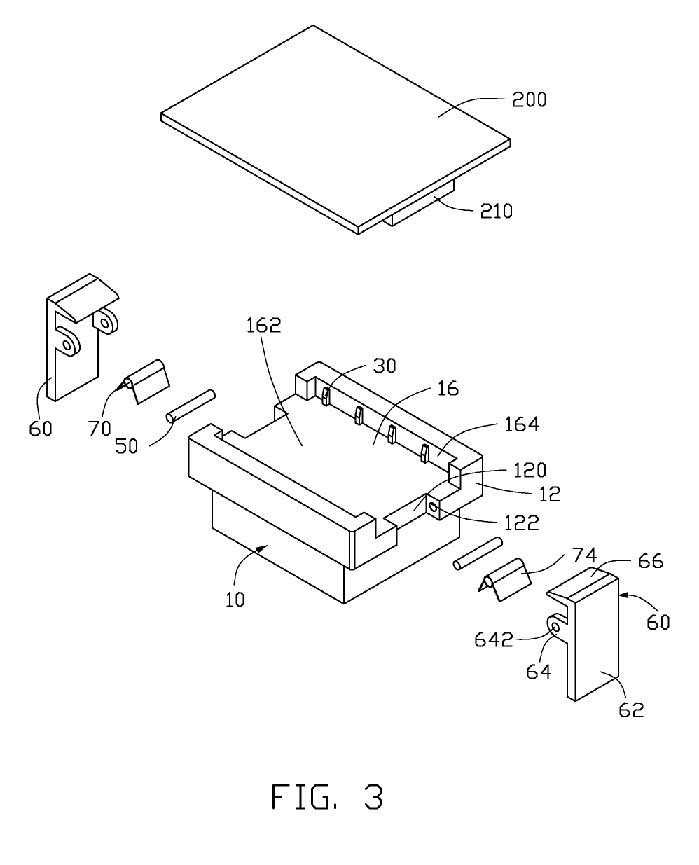

FIGS. 2 and 3 illustrate the main body 10. The main body 10 comprises a base 11 and a receiving frame 20 mounted on a top surface of the base 11. A plurality of signal pins 40 is mounted on the top surface of the base 11 and received in the receiving frame 20. In the embodiment, the number of the signal pins 40 is ten, and the signal pins 40 are symmetrically mounted on the base 11 in two rows. The signal pins 40 are connected to corresponding programming pins (not shown) of a connector (not shown) of the programming device mounted in the receiving frame 20. In another embodiment, the receiving frame 20 can be omitted and the signal pins 40 can coupled with the programming device by welded data lines.

A bottom surface of the base 11 defines a groove 16 extending through opposite ends. Each of opposite ends of the base 11 respectively defines an opening 120 communicating with the corresponding groove 16. The groove 16 comprises a top surface 162 and two opposite side surfaces 164. Opposite ends of each opening 120 respectively define two rotation holes 122. A plurality of connecting pins 30 is mounted to the top surface 162 and completely received in the groove 16. The connecting pins 30 abut against the side surfaces 164. In the embodiment, the number of the connecting pins 30 is eight, the connecting pins 30 are symmetrically mounted in two rows and respectively connected to the eight signal pins of the signal pins 40.

Each clipping element 60 comprises a board 62, two rotation portions 64 extending from opposite side surfaces of the board 63, and a latch 66 extending from a bottom end of the board 62. Each rotation portion 64 defines a through hole 642.

Each resilient member 70 comprises a cylinder-shaped connecting portion 72 and two elastic pieces 74 forming an angle extending from a circumference of the elastic portion 72. The two elastic pieces 74 are aligned in V-shape.

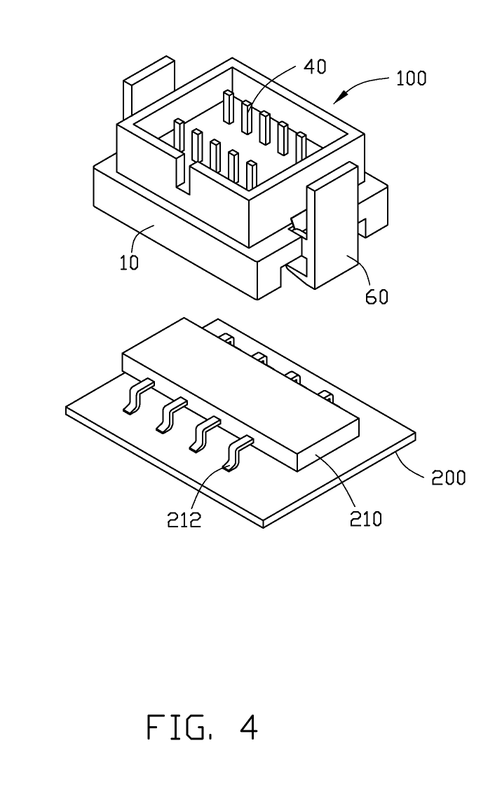

FIG. 4 illustrates an assembly of the clip 100, each spindle 50 is extended through one of the through holes 642 of the corresponding clipping element 60, the connecting portion 72 of the corresponding torsion spring 70, and the other through hole 642 of the corresponding clipping element 60 in that order, and then the spindle 50 is rotatably mounted to the corresponding end of the main body 10. One of the elastic pieces 74 resists against the board 62 of the clipping element 60, and the other elastic piece 74 resists against a sidewall of the receiving frame 20 bounding the opening 12 between the rotation holes 122. Therefore, the clipping elements 60 can clip the BIOS chip 210 to the motherboard 200 under force of the resilient member 70.

In use, top portions of the two clipping elements 60 are pressed to stretch relative to the two latches 66. The two resilient members 70 are elastically deformed. The mother board 200 is attached to the groove 16 of the main body 10. The clipping elements 60 are loosened and the resilient members 70 elastically recover. The latches 66 are blocked under the chip 210. At this time, the connecting pins 30 of the clip 100 respectively electrically contact chip pins 212 of the BIOS chip 210. After the chip 210 is clipped by the clip 100, the programming device communicates with the signal pins 40 of the clip 100, therefore the programming device can communicate through the corresponding chip pins 212 with the chip 210 through the connecting pins 30 of the clip 100, to program the chip 210, which is very convenient. Furthermore, the chip 210 does not need to be removed from the motherboard 200 and soldered back on the motherboard 200 again during programming and testing, which can protect the chip 210 and the motherboard 200 from damage.

The embodiments shown and described above are only examples. Many details are often found in the art such as the other features of a clip. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A clip for a basic input/output system (BIOS) chip, the clip comprising:
a main body comprising a groove configured to receive the BIOS chip therein, a plurality of connecting pins receiving in the groove to couple with the BIOS chip, and a plurality of signal pins mounted on the main body electrically connected to the connecting pins and configured to couple with a programming device;
two clipping elements rotatably mounted to opposite ends of the main body and configured to latch the BIOS chip; and
two resilient members respectively mounted between the clipping elements and the main body.

2. The clip of claim 1, wherein the main body further comprises a receiving frame extending up from sides of the top of the main body and surrounding the plurality of signal pins.

3. The clip of claim 2, wherein each resilient member comprises a connecting portion mounted to a side surface of the main body and two elastic pieces extending from the connecting portion, the two elastic pieces abut against the corresponding receiving frame and the clipping elements respectively.

4. The clip of claim 1, wherein opposite ends of the main body each define an opening communicating with the groove, the clip further comprises two spindles, two opposite sidewalls bounding each opening each define a rotation hole to receive one of opposite ends of a corresponding spindle the two resilient elements are mounted to the two spindles respectively.

5. The clip of claim 4, wherein each resilient member comprises a connecting portion mounted to a side surface of the main body and two elastic pieces extending from the connecting portion, the elastic pieces are fitted around the corresponding spindle respectively, the two elastic pieces abut against the corresponding receiving frame and the clipping elements respectively.

6. The clip of claim 5, wherein each clipping element comprises a substantially rectangular board, two rotating portions substantially perpendicularly extending from the board and receiving in the corresponding two opening, each rotating portion defines a through hole for the corresponding spindle extending through.

7. The clip of claim 6, wherein a latch extends from a bottom end of the board of each clipping element, to support the BIOS chip.

8. The clip of claim 1, wherein the connecting pins abut against a side surface of the groove.

9. The clip of claim 1, wherein the number of the connecting pins is eight, the number of the signal pins is ten, the connecting pins are connected to the eight signal pins of the signal pins respectively.

10. A clip assembly comprising:
a basic input/output system (BIOS) chip comprising a plurality of chip pins;
a main body comprising a groove configured to receive the BIOS chip therein, a plurality of connecting pins receiving in the groove to respectively couple with the chip pins, and a plurality of signal pins attached to the main body electrically connected to the connecting pins and configured to couple with a programming device;
two clipping elements rotatably mounted to opposite ends of the main body and configured to latch the BIOS chip; and
two resilient members respectively mounted between the clipping elements and the main body.

11. The clip assembly of claim 10, wherein the main body further comprises a receiving frame extending up from sides of the top of the main body and surrounding the plurality of signal pins.

12. The clip assembly of claim 11, wherein each resilient member comprises a connecting portion mounted to a side surface of the main body and two elastic pieces extending from the connecting portion, the two elastic pieces abut against the corresponding receiving frame and the clipping elements respectively.

13. The clip assembly of claim 10, wherein opposite ends of the main body each define an opening communicating with the groove, the clip further comprises two spindles, two opposite sidewalls bounding each opening each define a rotation hole to receive one of opposite ends of a corresponding spindle the two resilient elements are mounted to the two spindles respectively.

14. The clip assembly of claim 13, wherein each resilient member comprises a connecting portion mounted to a side surface of the main body and two elastic pieces extending from the connecting portion, the elastic pieces are fitted around the corresponding spindle respectively, the two elastic pieces abut against the corresponding receiving frame and the clipping elements respectively.

15. The clip assembly of claim 14, wherein each clipping element comprises a substantially rectangular board, two rotating portions substantially perpendicularly extending from the board and receiving in the corresponding two opening, each rotating portion defines a through hole for the corresponding spindle extending through.

16. The clip assembly of claim 15, wherein a latch extends from a bottom end of the board of each clipping element, to support the BIOS chip.

17. The clip assembly of claim 10, wherein the connecting pins abut against a side surface of the groove.

18. The clip assembly of claim 10, wherein the number of the connecting pins is eight, the number of the signal pins is ten, the connecting pins are connected to the eight signal pins of the signal pins respectively.

19. A clip for a basic input/output system (BIOS) chip comprising:
a main body defining a space for receiving a BIOS chip;
a plurality of connecting pins positioned in the defined space and connectable to the BIOS chip;
a plurality of signal pins mounted on the main body and electrically connected to the plurality of connecting pins;
a first clip element rotatably mounted on a first end of the main body;
a second clip element rotatably mounted on a second end of the main body, opposite the first end;
a first resilient member mounted between the first clip element and the main body; and
a second resilient member mounted between the second clip element and the main body;
wherein, the first clip element and second clip element are positionable to retain the BIOS chip is the defined space; and
wherein, the plurality of signal pins are couplable to a programming device.
